(19) United States
(12) Patent Application Publication
(10) Pub. No.: US 2021/0110158 A1
(43) Pub. Date: Apr. 15, 2021

(54) METHOD AND APPARATUS FOR ESTIMATING LOCATION IN A STORE BASED ON RECOGNITION OF PRODUCT IN IMAGE

(71) Applicant: LG ELECTRONICS INC., Seoul (KR)

(72) Inventors: Yoo Gyeong LEE, Seoul (KR); Ye Ri LEE, Seoul (KR)

(73) Assignee: LG ELECTRONICS INC., Seoul (KR)

(21) Appl. No.: 16/711,040

(22) Filed: Dec. 11, 2019

(30) Foreign Application Priority Data
Oct. 14, 2019 (KR) 10-2019-0127181

(51) Int. Cl. G06K 9/00; G06N 3/04; G06N 3/08; G06Q 10/08; G06T 11/00; G06T 7/90

(52) U.S. Cl. CPC G06K 9/00664; G06N 3/0454; G06N 3/08; G06T 2207/30244; G06T 11/00; G06T 7/90; G06T 2207/20084; G06Q 10/087

(57) ABSTRACT

A method of estimating an indoor location includes loading an image captured by a first terminal, recognizing a product by applying a first machine learning model based on machine learning to the loaded image, acquiring product information related to the product from the recognized product, estimating a location of the first terminal based on a database including location information of the product and the product information, and controlling the first terminal to display information related to the location on the first terminal. A neural network for processing an image is a deep neural network generated through machine learning, and the image is inputted and outputted in an Internet of things (IoT) environment using a 5G network.

### CROSS-REFERENCE TO RELATED APPLICATION

Pursuant to 35 U.S.C. § 119(a), this application claims the benefit of earlier filing date and right of priority to Korean Patent Application No. 10-2019-0127181, filed in the Republic of Korea on Oct. 14, 2019, the entire disclosure of which is incorporated herein by reference.

### BACKGROUND

### 1. Technical Field

The present disclosure relates to a method and apparatus for estimating an indoor location.

### 2. Description of Related Art

Along with the proliferation of mobile devices, such as smartphones, and the increasing number of indoor spaces, such as stores or shopping malls, technologies for providing information on an indoor location of a user are being developed. A locationing method using a satellite has been generally used for outdoor spaces, in which there is no difficulty in receiving waves from a satellite, but waves of a satellite cannot be used in indoor spaces, and thus research is being conducted into various technologies for estimating an indoor location.

In particular, consumers have difficulty in finding a desired product in large stores, in which a wide variety of products is displayed. When products are rearranged in a large store, consumers experience great difficulty in finding products.

As one technology for estimating an indoor location, there is related art that uses a received signal strength indictor (RSSI) of a wireless LAN (Wi-Fi) access point (AP) or a beacon based on short-range communication.

Related art 1 discloses a technology for estimating a location of a cart by estimating the intensity of a signal received from an AP 300 in a store, and related art 2 discloses a technology for estimating an indoor location by applying a triangulation method to a response signal of a user device with respect to a beacon signal of a beacon based on Bluetooth short-range communication technology. The technologies disclosed in the related art mainly estimate an indoor location based on waves.

The above-described related art is technical information that the inventor holds for deriving the present disclosure or is acquired in the derivation process of the present disclosure, and is not necessarily a known technology disclosed to the general public before the application of the present disclosure.

### RELATED ART DOCUMENTS

### Patent Documents

Related art 1: Korean Patent Registration No. 10-1852026 (registered on Apr. 25, 2018)
Related art 2: Korean Patent Application Publication No. 10-2015-0092855 (published on Aug. 17, 2015)

### SUMMARY OF THE INVENTION

An aspect of the present disclosure is to provide a method and apparatus for estimating an indoor location of a terminal device based on a surrounding image of a terminal device, captured by the terminal device.

Another aspect of the present disclosure is to provide a method and apparatus for estimating an indoor location of a terminal device irrespective of the size of an indoor space in which the terminal device is located.

Aspects of the present disclosure are not limited to the above-mentioned aspects, and other aspects not mentioned above will be clearly understood by those skilled in the art from the following description.

According to an embodiment of the present disclosure, an indoor location of a terminal device may be estimated based on information on products from a surrounding image of the terminal device.

According to an embodiment of the present disclosure, an indoor location of a terminal device may be estimated by generating an image of a hidden portion even when a portion of products recognized from a surrounding image of the terminal device is hidden.

According to an embodiment of the present disclosure, an indoor location of a terminal device may be estimated based on a product name or representative color of products recognized from a surrounding image of the terminal device.

According to an embodiment of the present disclosure, a method of estimating an indoor location includes recognizing a product by applying a first machine learning model based on machine learning to an image captured by a terminal, acquiring product information related to the product from the recognized product, and estimating a location of the terminal based on a database including location information of the product and the product information.

The method may further include generating an image of a hidden product by applying a second machine learning model based on a generative model including any one of a generative adversarial network (GAN), a conditional GAN (cGAN), a deep convolution GAN (DCGAN), an auto-encoder, or a variational auto-encoder (VAE) to the captured image, and acquiring product information from the generated product when a product is hidden by another product or a surrounding environment.

The indoor location estimating method may include estimating a location of the terminal device based on a representative color and product name of a product determined by applying machine learning models based on machine learning to the captured image.

The indoor location estimating method may include estimating a location of a terminal based on arrangement of representative colors of a plurality of products recognized from the captured image.

The indoor location estimating method may include estimating a location of a terminal based on a location change of representative colors of a plurality of products recognized from a plurality of captured images.

According to an embodiment of the present disclosure, an apparatus for estimating an indoor location based on machine learning may include a memory configured to store at least one code executed by a processor and a parameter of a learning model based on machine learning, and a database including a product name and location information of the product, wherein the memory stores codes that cause the processor to acquire product information related to the product from a product recognized by applying a first learning model to an image received from a terminal device through a network, and to estimate a location of the terminal device based on the database and the product information when the codes are executed by the processor.

The first learning model may be a learning model trained to extract a product name from a product recognized from an image using, as training data, an image and a product name of a product extracted from a database of products that are bought and sold in a store.

The memory may further store codes that cause generation of an image of a hidden portion by applying a generative model to a received image and recognition of a product name based on the generated image when a portion of the product is hidden in the received image.

According to an embodiment of the present disclosure, an apparatus for estimating an indoor location may include a processor, a memory electrically connected to the processor and configured to store at least one code executed by the processor and a parameter of a learning model based on machine learning, and a camera configured to capture a surrounding image, wherein the memory stores codes that cause the processor to acquire product information including representative color or a product name of the product from a product recognized by applying the learning model to the surrounding image captured by the camera, and to estimate a location in a store based on a search result of the product information from a database including a product name and location information of a product in the store when the codes are executed by the processor.

Other embodiments, aspects, and features in addition those described above will become clear from the accompanying drawings, the claims, and the detailed description of the present disclosure.

The apparatus and method for estimating an indoor location according to embodiments of the present disclosure may estimate an indoor location based on recognition of an image that is captured without being influenced by a change in the surrounding environment, thereby increasing the accuracy of indoor location estimation.

According to embodiments of the present disclosure, an indoor location may be estimated based on machine learning based on product information of a product recognized from an image, and thus a computational load for estimating an indoor location may be reduced.

According to embodiments of the present disclosure, an image of a product may be generated based on a generative model, and thus even when a product is partially hidden in a captured image, an indoor location may be accurately estimated.

According to embodiments of the present disclosure, an indoor location may be estimated based on the product name and color information of a product recognized from an image, and thus even when only a portion of the product name is recognized, the indoor location may be estimated.

According to embodiments of the present disclosure, an indoor location may be estimated based on color information of a product recognized from an image, and thus even when it is difficult to difficult to recognize a product name, the indoor location may be estimated.

The effects of the present disclosure are not limited to those mentioned above, and other effects not mentioned may be clearly understood by those skilled in the art from the following description.

### BRIEF DESCRIPTION OF THE DRAWINGS

The above and other aspects, features, and advantages of the present disclosure will become apparent from the detailed description of the following aspects in conjunction with the accompanying drawings, in which:

FIG. 1 is a diagram of an environment for performing an image resolution increasing method according to an embodiment of the present disclosure;

FIG. 2 is a diagram showing a system for generating a neural network for processing an image according to an embodiment of the present disclosure;

FIG. 3 is a diagram for explaining a neural network for processing an image according to an embodiment of the present disclosure;

FIG. 4 is a flowchart for explaining a method of estimating an indoor location of an apparatus for estimating an indoor location according to an embodiment of the present disclosure;

FIG. 5 is a diagram for explaining a method of estimating an indoor location depending on indoor movement of a terminal device according to an embodiment of the present disclosure;

FIG. 6 is a diagram for explaining a method of generating an image of a hidden portion of a product by applying a generative model according to an embodiment of the present disclosure;

FIGS. 7 to 9 are flowcharts for explaining a method of estimating an indoor location according to other embodiments of the present disclosure; and

FIG. 10 is a diagram for explaining a method of determining a direction in which a terminal device moves according to an embodiment of the present disclosure.

### DETAILED DESCRIPTION OF THE EMBODIMENTS

The advantages and features of the present disclosure and methods to achieve them will be apparent from the embodiments described below in detail in conjunction with the accompanying drawings. However, the description of particular example embodiments is not intended to limit the present disclosure to the particular exemplary embodiments disclosed herein, but on the contrary, it should be understood that the present disclosure is to cover all modifications, equivalents and alternatives falling within the spirit and scope of the present disclosure. The example embodiments disclosed below are provided so that the present disclosure will be thorough and complete, and also to provide a more complete understanding of the scope of the present disclosure to those of ordinary skill in the art. In the interest of clarity, not all details of the relevant art are described in detail in the present specification if it is determined that such details are not necessary to obtain a complete understanding of the present disclosure.

The terminology used herein is used for the purpose of describing particular example embodiments only and is not intended to be limiting. As used herein, the articles “a,” “an,” and “the,” include plural referents unless the context clearly dictates otherwise. The terms “comprises,” “comprising,” “includes,” “including,” “containing,” “has,” “having” or other variations thereof are inclusive and therefore specify the presence of stated features, integers, steps, operations, elements, and/or components, but do not preclude the presence or addition of one or more other features, integers, steps, operations, elements, components, and/or groups thereof. Furthermore, terms such as “first,” “second,” and other numerical terms may be used herein only to describe various elements, but these elements should not be limited by these terms. These terms are only used to distinguish one element from another.

Hereinafter, embodiments of the present disclosure will be described in detail with reference to the accompanying drawings. Like reference numerals designate like elements throughout the specification, and overlapping descriptions of the elements will be omitted.

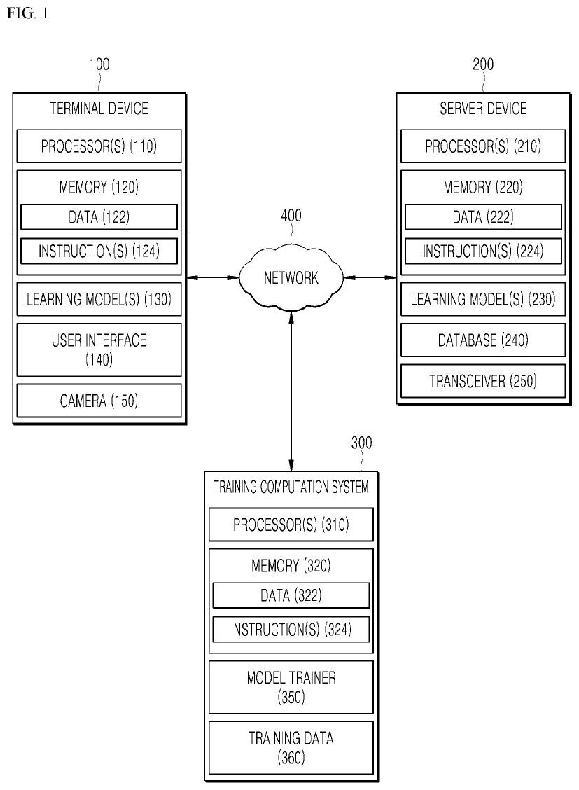

FIG. 1 is a diagram of an environment for performing an image resolution increasing method according to an embodiment of the present disclosure.

The environment for performing the image resolution increasing method according to an embodiment of the present disclosure may include a terminal device 100, a server device 200, a training computation system 300, and a network 400 configured to support communication therebetween.

The terminal device 100 may support Internet of things (IoT), Internet of everything (IoE), Internet of small things (IoST), and so forth, and may support machine to machine (M2M) communication, device to device (D2D) communication, and so forth.

The terminal device 100 may estimate the image resolution increasing method using big data, an artificial intelligence (AI) algorithm, and/or a machine learning algorithm in a 5G environment supporting the IoT.

The terminal device 100 may be any type of computing device, for example, a personal computer, a smartphone, a tablet PC, a game console, a projector, a wearable device (for example, a smart glass or a head mounted display (HMD)), a set-top-box (STB), a desk top computer, digital signage, a smart TV, or a network attached storage (NAS), and may be implemented as a fixed-type device or a mobile device. The terminal device 100 may be implemented as a mobile device in a store, for example, a cart or a mobile robot.

That is, the terminal device 100 may be implemented in the form of various electronic products used in houses or stores, and may also be applied to a fixed-type robot or a mobile robot.

The terminal device 100 may include a wireless transceiver that is capable of transmitting or receiving data in a 5G environment supporting the IoT. The wireless transceiver may include at least one of a broadcast reception module, a mobile communication module, a wireless Internet module, a short-range communication module, or a location information module.

The broadcast reception module may receive a broadcast signal and/or information related to a broadcast from an external broadcast management server through a broadcast channel.

The mobile communication module transmits and receives a radio signal to and from at least one of a base station, an external terminal, a server, and the like on a mobile communication network established according to technical standards or communication methods for mobile communication (for example, Global System for Mobile communication (GSM), Code Division Multi Access (CDMA), Code Division Multi Access 2000 (CDMA2000), Enhanced Voice-Data Optimized or Enhanced Voice-Data Only (EV-DO), Wideband CDMA (WCDMA), High Speed Downlink Packet Access (HSDPA), High Speed Uplink Packet Access (HSUPA), Long Term Evolution (LTE), Long Term Evolution-Advanced (LTE-A), and the like) and 5G (Generation) communication systems.

The wireless Internet module refers to a module for wireless Internet access, and may be embedded in the terminal device 100 or externally. The wireless Internet module is configured to transmit and receive wireless signals over a communication network that is based on wireless Internet technologies.

The wireless internet technologies may include Wireless LAN (WLAN), Wireless-Fidelity (Wi-Fi), Wi-Fi Direct, Digital Living Network Alliance (DLNA), Wireless Broadband (WiBro), World Interoperability for Microwave Access (WiMAX), High Speed Downlink Packet Access (HSDPA), High Speed Uplink Packet Access (HSUPA), Long Term Evolution (LTE), and Long Term Evolution-Advanced (LTE-A).

The short-range communication module is for short-range communication, and may support the short-range communication by using at least one of Bluetooth (Bluetooth™), Radio Frequency Identification (RFID), Infrared Data Association (IrDA), Ultra Wideband (UWB), ZigBee, Near Field Communication (NFC), Wireless-Fidelity (Wi-Fi), Wi-Fi Direct, or Wireless Universal Serial Bus (Wireless USB) technologies.

The location information module may be a module for acquiring the location (or the current location) of a mobile electronic device, and representative examples thereof may be a global positioning system (GPS) module or a wireless fidelity (Wi-Fi) module. For example, when a GPS module is used, an electronic device may acquire the location of a mobile electronic device using a signal transmitted from a GPS satellite.

The terminal device 100 may include one or more processors 110 and a memory 120.

The one or more processors 110 may include any type of device for processing data, for example, a MCU, a GPU, or an AI accelerator chip. Here, the “processor” may, for example, refer to a data processing device embedded in hardware, which has a physically structured circuitry to perform a function represented by codes or instructions contained in a program.

Examples of the data processing device embedded in hardware may include a microprocessor, a central processor (CPU), a processor core, a multiprocessor, an application-specific integrated circuit (ASIC), and a field programmable gate array (FPGA), but the scope of the present disclosure is not limited thereto.

The processor 110 may estimate or predict at least one executable operation of the terminal device 100 based on information that is estimated or generated using a data analysis and machine learning algorithm (learning model). To this end, the processor 110 may control the electronic device to execute a predicted operation or an operation determined to be desired among the at least one executable operation.

The processor 110 may perform various functions which implement intelligent emulation (that is, a knowledge based system, an inference system, and a knowledge acquisition system). This may be applied to various types of systems (for example, a fuzzy logic system) including an adaptive system, a machine learning system, and an artificial neural network.

The terminal device 100 may include an output interface configured to output data obtained by processing the result of an operation by the processor 110.

The output interface may generate output related to sight, hearing, or tactile sensation, and may include at least one of a display, a sound output module, a haptic module, or an optical output module.

The display may display (output) information processed by the terminal device 100. For example, the display may display execution screen information of an application program driven in the terminal device 100 and user interface (UI) and graphic user interface (GUI) information in accordance with the execution screen information.

The display may implement a touchscreen by forming a layered structure or being integrated with touch sensors. The touchscreen may function as a user input interface for providing an input interface between the terminal device 100 and a user, and may simultaneously provide an output interface between the terminal device 100 and the user. The display may indicate the point at which the terminal device 100 is currently located on a map using a user interface 140.

The memory 120 may include one or more non-transitory storage media such as RAM, ROM, EEPROM, EPROM, flash memory devices, or magnetic disks. The memory 120 may store data 122 and instructions 124 for causing the terminal device 100 to perform operations when executed by the processors 110.

The terminal device 100 may receive commands from a user, including via the user interface 140, and may also transfer output information to the user. The user interface 140 may include various input interfaces such as a keyboard, a mouse, a touchscreen, a microphone, or a camera, and various output interfaces such as a monitor, a speaker, or a display.

The terminal device 100 may include an interface that functions as a path with various types of external devices connected to the terminal device 100. The interface may include at least one of a wired/wireless headset port, an external charger port, a wired/wireless data port, a memory card port, a port which connects a device equipped with an identification module, an audio input/output (I/O) port, a video input/output (I/O) port, and an earphone port. In response to connection of an external device to the interface, the terminal device 100 may perform appropriate control related to the connected external device.

The user may select a video image to be processed by the terminal device 100 through the user interface 140. For example, the user may select a target video image, the resolution of which the user wants to increase, through a mouse, a keyboard, a touchscreen, or the like.

The user interface 140 may include a mechanical input interface (or a mechanical key, for example, a button located on a front, rear, or side surface of the terminal device 100, a dome switch, a jog wheel, or a jog switch) and a touch type input interface. For example, the touch type input interface may be formed by a virtual key, a soft key, or a visual key which is disposed on the touch screen through a software process or a touch key which is disposed on a portion other than the touch screen.

According to an embodiment, the terminal device 100 may also store or include learning models 130 to which artificial intelligence technology is applied. For example, the learning models 130 to which the artificial intelligence technology is applied may be or may include various learning models such as a deep neural network or a different type of machine learning model.

In this specification, an artificial neural network which is trained using training data to determine parameters may be referred to as a learning model or a trained model.

The learning models 130 may be implemented by hardware, software, or a combination of hardware and software. When a part of or the entire learning model is implemented by software, one or more commands which configure the learning model may be stored in the memory 120.

Artificial intelligence (AI) is an area of computer engineering science and information technology that studies methods to make computers mimic intelligent human behaviors such as reasoning, learning, self-improving, and the like.

In addition, artificial intelligence does not exist on its own, but is rather directly or indirectly related to a number of other fields in computer science. In recent years, there have been numerous attempts to introduce an element of the artificial intelligence into various fields of information technology to solve problems in the respective fields.

Machine learning is an area of artificial intelligence that includes the field of study that gives computers the capability to learn without being explicitly programmed.

Specifically, machine learning may be a technology for researching and constructing a system for learning, predicting, and improving its own performance based on empirical data and an algorithm for the same. Machine learning algorithms, rather than only executing rigidly set static program commands, may be used to take an approach that builds models for deriving predictions and decisions from inputted data.

Numerous machine learning algorithms have been developed for data classification in machine learning. Representative examples of such machine learning algorithms for data classification include a decision tree, a Bayesian network, a support vector machine (SVM), an artificial neural network (ANN), and so forth.

Decision tree refers to an analysis method that uses a tree-like graph or model of decision rules to perform classification and prediction.

Bayesian network may include a model that represents the probabilistic relationship (conditional independence) among a set of variables. Bayesian network may be appropriate for data mining via unsupervised learning.

SVM may include a supervised learning model for pattern detection and data analysis, heavily used in classification and regression analysis.

ANN is a data processing system modelled after the mechanism of biological neurons and interneuron connections, in which a number of neurons, referred to as nodes or processing elements, are interconnected in layers.

ANNs are models used in machine learning and may include statistical learning algorithms conceived from biological neural networks (particularly of the brain in the central nervous system of an animal) in machine learning and cognitive science.

ANNs may refer generally to models that have artificial neurons (nodes) forming a network through synaptic interconnections, and acquires problem-solving capability as the strengths of synaptic interconnections are adjusted throughout training.

The terms ‘artificial neural network’ and ‘neural network’ may be used interchangeably herein.

An ANN may include a number of layers, each including a number of neurons.

Furthermore, the ANN may include synapses that connect the neurons to one another.

An ANN may be defined by the following three factors: (1) a connection pattern between neurons on different layers; (2) a learning process that updates synaptic weights; and (3) an activation function generating an output value from a weighted sum of inputs received from a lower layer.

ANNs include, but are not limited to, network models such as a deep neural network (DNN), a recurrent neural network (RNN), a bidirectional recurrent deep neural network (BRDNN), a multilayer perception (MLP), and a convolutional neural network (CNN).

An ANN may be classified as a single-layer neural network or a multi-layer neural network, based on the number of layers therein.

In general, a single-layer neural network may include an input layer and an output layer.

In general, a multi-layer neural network may include an input layer, one or more hidden layers, and an output layer.

The input layer receives data from an external source, and the number of neurons in the input layer is identical to the number of input variables. The hidden layer is located between the input layer and the output layer, and receives signals from the input layer, extracts features, and feeds the extracted features to the output layer. The output layer receives a signal from the hidden layer and outputs an output value based on the received signal. Input signals between the neurons are summed together after being multiplied by corresponding connection strengths (synaptic weights), and if this sum exceeds a threshold value of a corresponding neuron, the neuron may be activated and output an output value obtained through an activation function.

A deep neural network with a plurality of hidden layers between the input layer and the output layer may be the most representative type of artificial neural network which enables deep learning, which is one machine learning technique.

An ANN may be trained using training data. Here, the training may refer to the process of determining parameters of the artificial neural network by using the training data, to perform tasks such as classification, regression analysis, and clustering of inputted data. Such parameters of the artificial neural network may include synaptic weights and biases applied to neurons.

An artificial neural network trained using training data may classify or cluster inputted data according to a pattern within the inputted data.

Throughout the present specification, an artificial neural network trained using training data may be referred to as a trained model.

Herein below, learning paradigms of an artificial neural network will be described in detail.

Learning paradigms, in which an artificial neural network operates, may be classified into supervised learning, unsupervised learning, semi-supervised learning, and reinforcement learning.

Supervised learning is a machine learning method that derives a single function from the training data.

Among the functions that may be thus derived, a function that outputs a continuous range of values may be referred to as a regressor, and a function that predicts and outputs the class of an input vector may be referred to as a classifier.

In supervised learning, an artificial neural network may be trained with training data that has been given a label.

Here, the label may refer to a target answer (or a result value) to be guessed by the artificial neural network when the training data is inputted to the artificial neural network.

Throughout the present specification, the target answer (or a result value) to be guessed by the artificial neural network when the training data is inputted may be referred to as a label or labeling data.

Throughout the present specification, assigning one or more labels to training data in order to train an artificial neural network may be referred to as labeling the training data with labeling data.

Training data and labels corresponding to the training data together may form a single training set, and as such, they may be inputted to an artificial neural network as a training set.

The training data may exhibit a number of features, and the training data being labeled with the labels may be interpreted as the features exhibited by the training data being labeled with the labels. In this situation, the training data may represent a feature of an input object as a vector.

Using training data and labeling data together, the artificial neural network may derive a correlation function between the training data and the labeling data. Then, through evaluation of the function derived from the artificial neural network, a parameter of the artificial neural network may be determined (optimized).

Unsupervised learning is a machine learning method that learns from training data that has not been given a label.

More specifically, unsupervised learning may be a training scheme that trains an artificial neural network to discover a pattern within given training data and perform classification by using the discovered pattern, rather than by using a correlation between given training data and labels corresponding to the given training data.

Examples of unsupervised learning include, but are not limited to, clustering and independent component analysis.

Examples of artificial neural networks using unsupervised learning include, but are not limited to, a generative adversarial network (GAN) and an autoencoder (AE).

GAN is a machine learning method in which two different artificial intelligences, a generator and a discriminator, improve performance through competing with each other.

The generator may be a model generating new data that generates new databased on true data.

The discriminator may be a model recognizing patterns in data that determines whether inputted data is from the true data or from the new data generated by the generator.

Furthermore, the generator may receive and learn from data that has failed to fool the discriminator, while the discriminator may receive and learn from data that has succeeded in fooling the discriminator. Accordingly, the generator may evolve to fool the discriminator as effectively as possible, while the discriminator evolves to distinguish, as effectively as possible, between the true data and the data generated by the generator.

An auto-encoder (AE) is a neural network which aims to reconstruct its input as output.

More specifically, AE may include an input layer, at least one hidden layer, and an output layer.

Since the number of nodes in the hidden layer is smaller than the number of nodes in the input layer, the dimensionality of data is reduced, thus leading to data compression or encoding.

Furthermore, the data outputted from the hidden layer may be inputted to the output layer. Given that the number of nodes in the output layer is greater than the number of nodes in the hidden layer, the dimensionality of the data increases, thus leading to data decompression or decoding.

Furthermore, in the AE, the inputted data is represented as hidden layer data as interneuron connection strengths are adjusted through training. The fact that when representing information, the hidden layer is able to reconstruct the inputted data as output by using fewer neurons than the input layer may indicate that the hidden layer has discovered a hidden pattern in the inputted data and is using the discovered hidden pattern to represent the information.

Semi-supervised learning is machine learning method that makes use of both labeled training data and unlabeled training data.

One semi-supervised learning technique involves reasoning the label of unlabeled training data, and then using this reasoned label for learning. This technique may be used advantageously when the cost associated with the labeling process is high.

Reinforcement learning may be based on a theory that given the condition under which a reinforcement learning agent may determine what action to choose at each time instance, the agent may find an optimal path to a solution solely based on experience without reference to data.

Reinforcement learning may be performed mainly through a Markov decision process.

Markov decision process consists of four stages: first, an agent is given a condition containing information required for performing a next action; second, how the agent behaves in the condition is defined; third, which actions the agent should choose to get rewards and which actions to choose to get penalties are defined; and fourth, the agent iterates until future reward is maximized, thereby deriving an optimal policy.

An artificial neural network is characterized by features of its model, the features including an activation function, a loss function or cost function, a learning algorithm, an optimization algorithm, and so forth. Also, the hyperparameters are set before learning, and model parameters may be set through learning to specify the architecture of the artificial neural network.

For instance, the structure of an artificial neural network may be determined by a number of factors, including the number of hidden layers, the number of hidden nodes included in each hidden layer, input feature vectors, target feature vectors, and so forth.

Hyperparameters may include various parameters which need to be initially set for learning, much like the initial values of model parameters. Also, the model parameters may include various parameters sought to be determined through learning.

For instance, the hyperparameters may include initial values of weights and biases between nodes, mini-batch size, iteration number, learning rate, and so forth. Furthermore, the model parameters may include a weight between nodes, a bias between nodes, and so forth.

Loss function may be used as an index (reference) in determining an optimal model parameter during the learning process of an artificial neural network. Learning in the artificial neural network involves a process of adjusting model parameters to reduce the loss function, and the purpose of learning may be to determine the model parameters that minimize the loss function.

Loss functions typically use means squared error (MSE) or cross entropy error (CEE), but the present disclosure is not limited thereto.

Cross-entropy error may be used when a true label is one-hot encoded. One-hot encoding may include an encoding method in which among given neurons, only those corresponding to a target answer are given 1 as a true label value, while those neurons that do not correspond to the target answer are given 0 as a true label value.

In machine learning or deep learning, learning optimization algorithms may be deployed to minimize a cost function, and examples of such learning optimization algorithms include gradient descent (GD), stochastic gradient descent (SGD), momentum, Nesterov accelerate gradient (NAG), Adagrad, AdaDelta, RMSProp, Adam, and Nadam.

GD includes a method that adjusts model parameters in a direction that decreases the output of a cost function by using a current slope of the cost function.

The direction in which the model parameters are to be adjusted may be referred to as a step direction, and a size by which the model parameters are to be adjusted may be referred to as a step size.

Here, the step size may mean a learning rate.

GD obtains a slope of the cost function through use of partial differential equations, using each of model parameters, and updates the model parameters by adjusting the model parameters by a learning rate in the direction of the slope.

SGD may include a method that separates the training dataset into mini batches, and by performing gradient descent for each of these mini batches, increases the frequency of gradient descent.

Adagrad, AdaDelta and RMSProp may include methods that increase optimization accuracy in SGD by adjusting the step size, and may also include methods that increase optimization accuracy in SGD by adjusting the momentum and step direction. Adam may include a method that combines momentum and RMSProp and increases optimization accuracy in SGD by adjusting the step size and step direction. Nadam may include a method that combines NAG and RMSProp and increases optimization accuracy by adjusting the step size and step direction.

Learning rate and accuracy of an artificial neural network rely not only on the structure and learning optimization algorithms of the artificial neural network but also on the hyperparameters thereof. Therefore, in order to obtain a good learning model, it is important to choose a proper structure and learning algorithms for the artificial neural network, but also to choose proper hyperparameters.

In general, the artificial neural network is first trained by experimentally setting hyperparameters to various values, and based on the results of training, the hyperparameters may be set to optimal values that provide a stable learning rate and accuracy.

The learning models 130 to which the aforementioned artificial intelligence technology is applied may be generated through a training operation by the training computation system 300, may be transmitted to the server device 200, and may then be transmitted to the terminal device 100 through the network 400, or may be directly transmitted to the terminal device 100 from the training computation system 300.

The training computation system 300 or the server device 200 may transmit a plurality of learning models, which are trained via machine learning or deep learning, to the terminal device 100, either periodically or in response to a request.

Each of the learning models 130 may be a neural network for processing an image, and may be a learning model that is trained to process a frame image of a still image or a video image in order to search for a bounding box of a product from an image when a video image or a still image is inputted, or may be a learning model using a CNN or region-based CNN (R-CNN) method. The learning model trained to recognize a product may be a learning model that is trained using, as training data, images of a product extracted from a database of products that are bought and sold in a store.

The database may be configured by extracting a product image from an image that is captured while moving inside the store and mapping the image to a location at which the product is photographed.

According to another embodiment, the database may be configured by inputting images formed by photographing products, which are bought and sold in the store, and locations at which the products are displayed.

The learning models 130 may be a neural network for processing an image, and may be a learning model that is trained to recognize a product name in a bounding box of the recognized product or to recognize the bounding box including a product name from the bounding box of the product and recognize the product name again. Prior to input into the learning models 130, image pre-processing such as conversion to a black-and-white image from a color image, histogram equalization, or binarization may be selectively performed. The learning model trained to recognize the product name may be a learning model that is trained to extract the product name from the recognized product using, as training data, an image and a product name of the product extracted from the database of products that are bought and sold in the store.

The learning models 130 may be a neural network for processing an image, may be a neural network trained using, as training data, a product image labeled with a product name, and may be a learning model that is trained to receive an image of the recognized product and to estimate a product name.

The learning models 130 may be a neural network for processing an image, and may be a learning model that is trained to generate a product image using a generative model when a product image cannot be appropriately recognized from a bounding box of the recognized product, for example, when the product image is partially hidden by a surrounding object or a person. The generative model may be configured to include an artificial neural network, and may be learned using a machine learning algorithm or a deep learning algorithm. In detail, the generative model may include at least one of a generative adversarial network (GAN), a conditional GAN (cGAN), a deep convolution GAN ((DCGAN), an auto-encoder, or a variational auto-encoder (VAE). The situation in which the learning model is trained to include the generative adversarial network (GAN) will be additionally described below.

In general, the learning models 130 may be transmitted to and stored in the server device 200 or the terminal device 100 in the state in which the learning models 130 can be applied to an image after the training computation system 300 performs a training operation on the learning models 130, but in some embodiments, the learning models 130 may be updated or upgraded through additional training in response to a request from the terminal device 100 or the server device 200.

The learning models 130 stored in the terminal device 100 may be some of the learning models 130 generated by the training computation system 300, and as necessary, new learning models may be generated by the training computation system 300 and may be transferred to the server device 200 or the terminal device 100.

As another example, the learning models 130 may be stored in the server device 200 rather than being stored in the terminal device 100, and may also provide a function required by the terminal device 100 in the form of a streaming service.

The server device 200 may include processors 210 and a memory 220 and, in general, may have higher processing capability and higher memory capacity than the terminal device 100. Thus, depending on the implementation of the system, heavy learning models 230 that require relatively large processing capability for application may be stored in the server device 200, and lightweight learning models 130 that require relatively small processing capability for application may be stored in the terminal device 100. For example, a learning model that recognizes a product from a captured image and a learning model that completes a scene of a product image when a recognized product is hidden may be stored in the server device 200, and may provide a required function in the form of a streaming service to the terminal device 100.

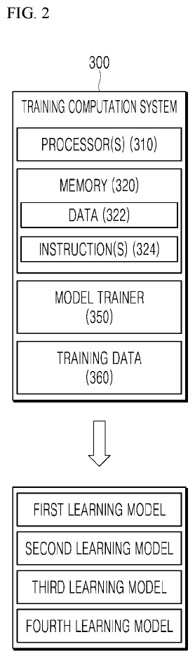

FIG. 2 is a diagram showing a system for generating a neural network for processing an image according to an embodiment of the present disclosure.

The training computation system 300 may include one or more processors 310 and a memory 320. The training computation system 300 may include a model trainer 350, for generating a plurality of learning models applicable to an image, and training data 360.

The training computation system 300 may be implemented as a plurality of server sets as well as a single server, a cloud server, or a combination thereof.

That is, the training computation system 300 may be provided in a plural number to configure a training computation system set (or a cloud server), and at least one training computation system 300 included in the training computation system set may analyze or learn data through distributed processing to derive a result.

The training computation system 300 may generate a plurality of learning models with different uses through the model trainer 350.

For example, a first learning model may be a learning model trained to recognize a product from a captured image using, as training data, an image of a product extracted from a database of products that are bought and sold in the store. A second learning model may be a learning model trained to extract a product name from a product recognized from an image using, as training data, an image and a product name of the product extracted from the database of products that are bought and sold in the store. A third learning model may be a learning model trained to estimate a representative color from a product recognized from an image, based on clustering or other machine learning. A fourth learning model may be a learning model trained to complete a scene of a product image that is hidden using, as training data, an image of a product extracted from the database of products that are bought and sold in the store.

When a learning model includes a neural network, the first learning model and the second learning model may have different configurations. For example, the first learning model may be a neural network for processing an image formed with two hidden layers, but another image may be a neural network for processing an image with four hidden layers.

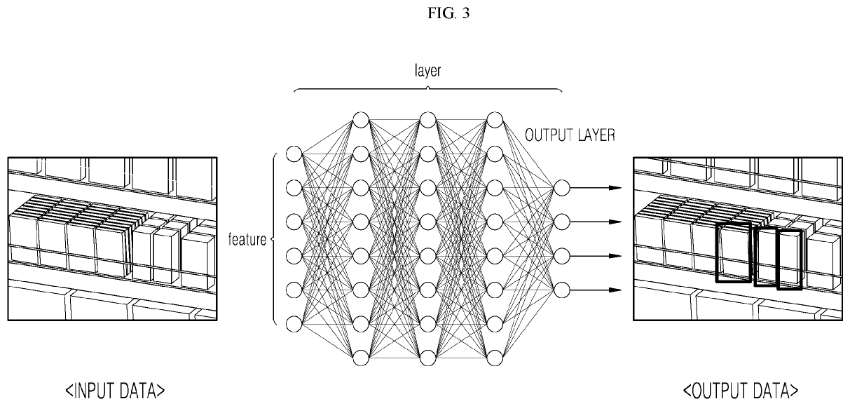

FIG. 3 is a diagram for explaining a neural network for processing an image according to an embodiment of the present disclosure.

The neural network of FIG. 3 may include an input layer, a hidden layer, and an output layer. The number of input nodes may be determined depending on the number of features, and as the number of nodes increases, the complexity or dimensionality of the neural network may increase. In addition, as the number of hidden layers increases, the complexity or dimensionality of the neural network may increase.

The number of features, the number of input nodes, the number of hidden layers, and the number of nodes in each layer may be determined by the designer of the neural network, and as the complexity increases, the processing time may increase, but enhanced performance may be achieved.

When an initial neural network configuration is designed, the neural network may be trained using training data. Images of products that are bought and sold in the store may be used as training data for a neutral network for recognizing a product, and an image and product name set of the product extracted from the database of products that are bought and sold in the store or a written letter style image and text set may be used as training data of a neural network for recognizing a product name. Images of products that are bought and sold in the store may be used as training data of a neural network for completing a scene of an image of a hidden product.

When a neural network is trained using a supervised learning method through training data, a neural network model for processing an image appropriate for each learning model may be generated.

Processing speed and processing performance may be in a trade-off relationship, and a designer may change the initial configuration of the neural network, and thus may generate neutral networks for various learning models with different processing speeds and processing performances and may generate a learning model applicable to the terminal devices 100 with different performance.

The learning model may be implemented as hardware, software, or a combination of hardware and software, and when all or part of a learning model is implemented as software, one or more commands or parameters configuring the learning model may be stored in the memories 120, 220, and 320.

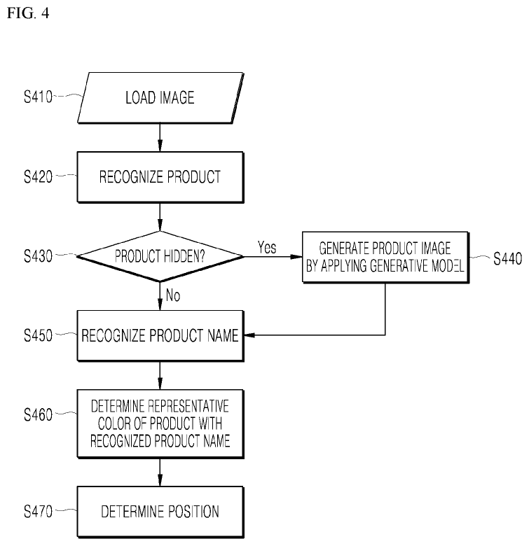

FIG. 4 is a flowchart for explaining a method of estimating an indoor location of an apparatus for estimating an indoor location according to an embodiment of the present disclosure.

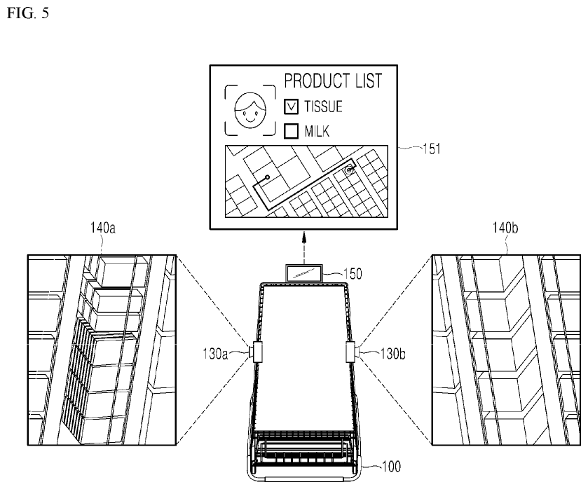

FIGS. 5 to 7 are diagrams showing a method for explaining a procedure in which the indoor location estimating method according to the embodiment of the present disclosure of FIG. 4 is performed on an image.

The apparatus for estimating an indoor location may have the same configuration as the terminal device 100 or the server device 200 described with reference to FIG. 1. A learning model for estimating an indoor space may be stored in the terminal device 100 or the server device 200 as described above, and the indoor location estimating method may be performed by the terminal device 100 or the server device 200.

When the indoor location estimating method is performed on the server device 200, the server device 200 may receive product images 140a and 140b captured by cameras 130a and 130b of the terminal device 100 implemented as shown in FIG. 5. The captured image received by the terminal device 100 may be an image captured by a single camera installed at one side of the terminal device 100 or a plurality of cameras installed at opposite sides of the terminal device 100. Then, the server device 200 may transmit, to the terminal device 100, information on the location at which the terminal device 100 is estimated to be located by applying a plurality of learning models to the received product images 140a and 140b. The terminal device 100 may map the location information received through a wired or wireless network to store map information, and may display (151) the location information on a display 150.

When the indoor location estimating method is performed by the terminal device 100, the terminal device 100 may estimate the location of the terminal device 100 by applying learning models transmitted from the server device 200 or the training computation system 300 to the product images 140a and 140b captured by the cameras 130a and 130b of the terminal device 100 implemented as shown in FIG. 5. The terminal device 100 may receive store map information from the server device 200, and may map and display the location information.

The apparatus for estimating an indoor location may load an image (S410). The image may be captured by an apparatus with a camera installed therein, or may be an image received from an external device via wired or wireless communication. In addition, the image may be a still image including a single image or a video image including a plurality of images, and the apparatus for estimating an indoor location may extract some frame images from the video image and may load the frame images.

The apparatus for estimating an indoor location may recognize a region in which a product is located from the loaded image based on a neural network for processing an image for recognizing a product. The neural network for processing an image for recognizing a product may process an image loaded according to a learning model of a configuration of a CNN or region-based CNN (R-CNN), fast R-CNN, faster R-CNN, region-based fully convolutional network (R-FCN), or You Only Look Once (YOLO) or single shot multibox detector (SSD), and may display a bounding box on the product recognized from the image.

The apparatus for estimating an indoor location may determine an extent to which a product is hidden prior to or after recognizing the location at which the product is located from the loaded image (S430).

The neural network for processing an image for recognizing a product may recognize a product even when a portion of a product is hidden, according to the structure of the learning model. The apparatus for estimating an indoor location may determine an extent to which a product is hidden with respect to a region of the recognized product. For example, when it is possible to recognize a portion of a product name from a product region, a portion of which is hidden, and it is possible to specify the product from a database in which product names are stored using the recognized portion of the product name, the indoor location estimating method may proceed. In contrast, when it is not possible to specify the product from the database in which product names are stored using the recognized portion of the product name, for example, when a plurality of products include the same portion as the recognized portion of the product name or when the product is hidden such that the product name cannot be clearly recognized, the apparatus for estimating an indoor location may apply the generative model to generate a hidden product region (S440).

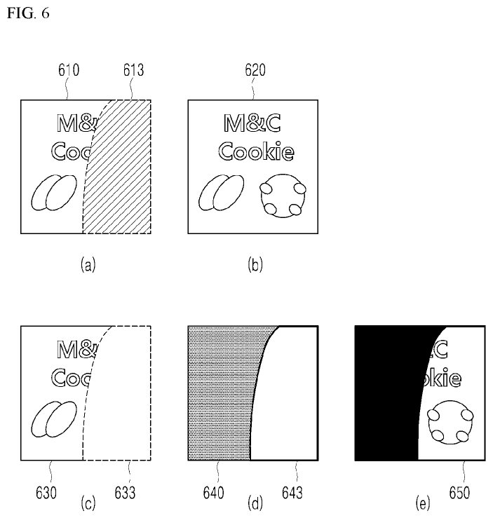

With reference to FIG. 6, a method of applying a generative model to generate a product region by an apparatus for estimating an indoor location will be described.

The apparatus for estimating an indoor location may generate a hidden portion of a product region based on a learning model using a generative model. The generative model may include any one of a generative adversarial network (GAN), conditional GAN (cGAN), deep convolution GAN (DCGAN), an auto-encoder, or a variational auto-encoder (VAE).

When the learning model is trained to include a generative adversarial network (GAN), the learning model may be a learning model trained to generate a product image to which a shape attribute vector modified from a shape attribute vector extracted from an original product image and a noise vector generated from the original product image or shape attribute implemented using a latent variable z are applied.

Referring to FIG. 6, a learning model including a generative adversarial network (GAN) (which includes all configurations including generative NNs, such as cGAN or DCGAN, and discriminative NNs) may be applied to a partially hidden (613) product image 610 to generate a product image 620, the hidden portion of which is scene-completed. The learning model may use, as input, a product image 630 from which a hidden portion 633 is excluded and a binary channel image 640 with a masked hidden portion 643. In addition, in order to complete a scene of the hidden portion of the learning model, a generative NN using dilated convolution may be applied as an intermediate layer. The discriminative NN may include a discriminator for discriminating a scene-completed entire image 620 of a product and a scene-completed image 650 of a region, and output of each discriminator may be lastly coupled to a vector to determine whether scene-completion is successful with respect to the coupled vector. A discriminative network may perform comparison on a vector coupled to an image of a product extracted from a database of products that are bought and sold in the store, and may determine whether scene-completion is successful.

The apparatus for estimating an indoor location may recognize a product name based on a learning model for recognizing text from a recognized product of a loaded image or an image generated based on a generative model (S450).

An image and product name set of the product extracted from the database of products that are bought and sold in the store or a written letter style image and text set may be used as training data of a learning model for recognizing a text.

Prior to recognition of text, the apparatus for estimating an indoor location may selectively perform conversion of a color image to a black-and-white image, binarization, removal of threshold-based noise image, morphology image processing such as dilation or erosion, and image pre-processing such as contour extraction of an object. The apparatus for estimating an indoor location may apply a neural network for processing an image for recognizing text based on a configuration such as inception, VGG, SSD, or YOLO to a product image, and may recognize a product name.

According to an embodiment, when the apparatus for estimating an indoor location fails to recognize a product name, settings of a camera for capturing an image may be controlled to be changed. For example, when a store is crowded and a product name cannot be continuously recognized from captured images, or when an extent to which a product is continuously hidden exceeds a preset reference, the photographing speed of a camera may be rapidly changed.

According to an embodiment, the apparatus for estimating an indoor location may estimate a representative color of a product by applying a learning model based on clustering or other machine learning to a product image (S460).

The clustering-based product color learning model may be a learning model based on mean shift clustering or continuously adaptive mean-shift clustering (CAMShift clustering). In addition, the neural network-based product color learning model may be a learning model based on gradient-weighted class activation mapping (Grad-CAM).

The apparatus for estimating an indoor location may estimate the location of a product by searching for a product name recognized from a database including location information of a product (S470).

According to an embodiment, the apparatus for estimating an indoor location may recognize product images from a plurality of captured images, may search for a plurality of product names from the database, and may estimate the indoor location of the terminal device 100. For example, as shown in FIG. 5, a plurality of product names may be searched for from the images 140a and 140b captured using the cameras 130a and 130b of the terminal device 100, which are set to photograph opposite directions. Thus, the apparatus for estimating an indoor location has the effect of being able to accurately estimate a location even when only a portion of a product name is recognized.

According to an embodiment, when an indoor location estimating method is implemented in the server device 200, the apparatus for estimating an indoor location may transmit the estimated location information to the terminal device 100, and may control the terminal device 100 to display a location.

According to another embodiment, when an indoor location estimating method is implemented in the terminal device 100, the apparatus for estimating an indoor location may control the display 150 to display (151) the estimated location.

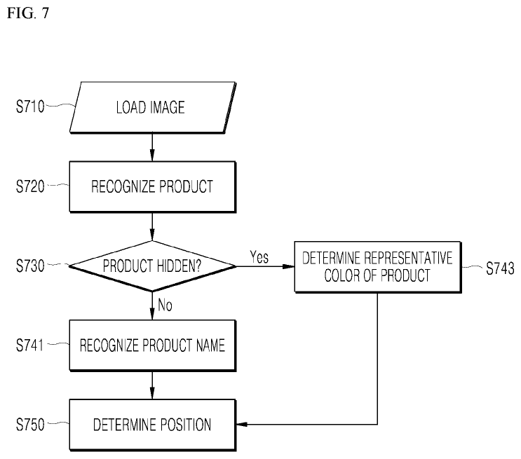

FIG. 7 is a flowchart for explaining an indoor location estimating method of an apparatus for estimating an indoor location according to another embodiment of the present disclosure. Hereinafter, a repeated description of the description of FIGS. 1 to 6 will be omitted.

Upon determining that products recognized in a captured image are hidden by a preset reference or greater (S730), the apparatus for estimating an indoor location may recognize a product name according to a learning model for processing an image for recognizing a text (S741), and may estimate the representative color of a product by applying a learning model based on clustering or other machine learning to the product (S743).

Then, the apparatus for estimating an indoor location may specify the product by searching for a name and representative color of the product recognized from a database including representative color information of the product, a product name, and location information of the product, and may estimate the location of the terminal device 100 (S750).

Accordingly, the apparatus for estimating an indoor location has the effect of being able to specify the product and estimate the location even when only a portion of the product name is recognized.

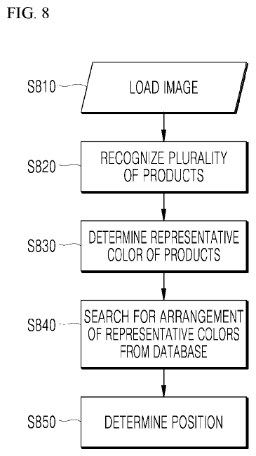

FIG. 8 is a flowchart for explaining an indoor location estimating method of an apparatus for estimating an indoor location according to another embodiment of the present disclosure. Hereinafter, a repeated description of the description of FIGS. 1 to 7 will be omitted.

The apparatus for estimating an indoor location may recognize a region in which a plurality of products is located from a captured image based on a neural network for processing an image for recognizing a product (S820), and may estimate the representative color of the recognized plurality of products by applying a learning model based on clustering or other machine learning to the plurality of products (S830).

Then, the apparatus for estimating an indoor location may specify the products by searching for products having the same representative color arrangement as the representative color arrangement of the recognized plurality of products, from a database including representative color information of products and location information of products (S840), and may estimate the location of the terminal device 100 (S850).

Accordingly, the apparatus for estimating an indoor location has the effect of being able to specify a product and estimate the location thereof even when only the color of products is recognized.

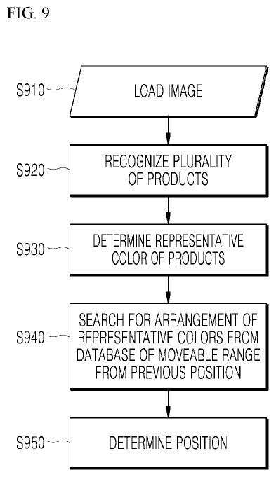

FIG. 9 is a flowchart for explaining an indoor location estimating method of an apparatus for estimating an indoor location according to another embodiment of the present disclosure. Hereinafter, a repeated description of the description of FIGS. 1 to 8 will be omitted.

The apparatus for estimating an indoor location may recognize a region in which a plurality of products is located from a captured image based on a neural network for processing an image for recognizing a product (S920), and may estimate the representative color of the recognized plurality of products by applying a learning model based on clustering or other machine learning to the plurality of products (S930).

Then, the apparatus for estimating an indoor location may specify a direction and range in which the terminal device 100 is moveable from a previously estimated location.

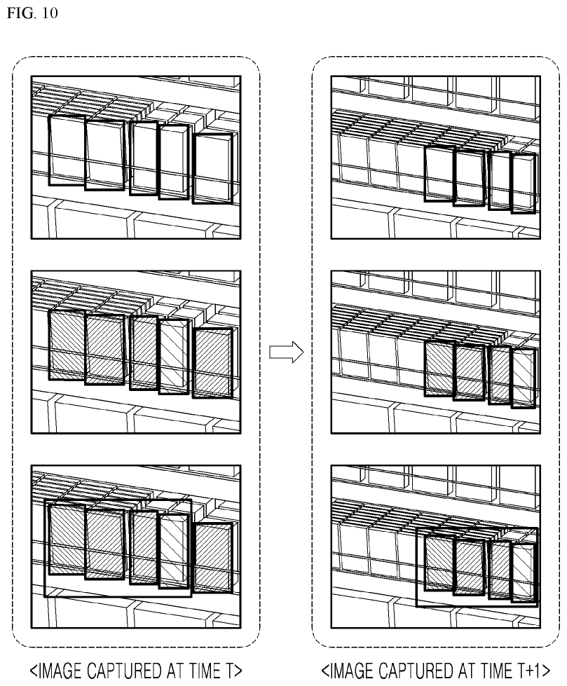

Based on a change between a location of the representative colors of the plurality of products recognized from an image captured at a specific time point by the terminal device 100 and a location of the representative colors of the plurality of products recognized from an image captured after a predetermined time elapses from the specific time point, the apparatus for estimating an indoor location may estimate a movement direction of the terminal device 100. For example, referring to FIG. 10, because the same arrangement of representative colors moves to the right in an image after a predetermined time elapses, the apparatus for estimating an indoor location may determine that the terminal device 100 has moved to the left.

The apparatus for estimating an indoor location may determine a movement speed of the terminal device 100 based on acceleration information estimated from a previously estimated location change of the terminal device 100 or acceleration information estimated from a sensor of the terminal device 100. Then, the apparatus for estimating an indoor location may search for the color arrangement of the plurality of products recognized from a currently captured image from information of products present in a moveable range in a previously determined location, based on the movement direction and movement speed of the terminal device 100 (S940), and may estimate the location of the terminal device 100 (S950).

Accordingly, the apparatus for estimating an indoor location has the effect of being able to specify a product and estimate the location thereof, and more rapidly estimate the location, even when only the color of the product is recognized.

The above present disclosure may be implemented as a computer readable code in a medium with a program recorded therein. The computer readable medium includes all types of recording devices in which data readable by a computer system readable may be stored. Examples of the computer readable medium include a Hard Disk Drive (HDD), a Solid State Disk (SSD), a Silicon Disk Drive (SDD), a ROM, a RAM, a CD-ROM, a magnetic tape, a floppy disk, an optical data storage device, etc. Moreover, the computer may include a processor 180 of a terminal.

The programs may be those specially designed and constructed for the purposes of the present disclosure or they may be of the kind well known and available to those skilled in the computer software arts. Examples of computer programs may include both machine codes, such as produced by a compiler, and higher-level codes that may be executed by the computer using an interpreter.

As used in the present disclosure (especially in the appended claims), the singular forms “a,” “an,” and “the” include both singular and plural references, unless the context clearly states otherwise. Also, it should be understood that any numerical range recited herein is intended to include all sub-ranges subsumed therein (unless expressly indicated otherwise) and accordingly, the disclosed numeral ranges include every individual value between the minimum and maximum values of the numeral ranges.

The order of individual steps in process claims according to the present disclosure does not imply that the steps must be performed in this order; rather, the steps may be performed in any suitable order, unless expressly indicated otherwise. The present disclosure is not necessarily limited to the order of operations given in the description. All examples described herein or the terms indicative thereof (“for example,” etc.) used herein are merely to describe the present disclosure in greater detail. Therefore, it should be understood that the scope of the present disclosure is not limited to the example embodiments described above or by the use of such terms unless limited by the appended claims. Also, it should be apparent to those skilled in the art that various modifications, combinations, and alternations may be made depending on design conditions and form factors within the scope of the appended claims or equivalents thereof.

The present disclosure is thus not limited to the example embodiments described above, and rather intended to include the following appended claims, and all modifications, equivalents, and alternatives falling within the spirit and scope of the following claims.

What is claimed is:

1. A method of estimating an indoor location, the method comprising:
loading an image captured by a first terminal;
applying a first machine learning model based on machine learning to the image;
recognizing a product within the image based on an output of the first machine learning model;
acquiring product information related to the product;
estimating a location of the first terminal based on location information of the product and the product information; and
controlling the first terminal to display information related to the location of the first terminal.

2. The method of claim 1, wherein the acquiring the product information comprises:
determining an extent to which the product is hidden in the image;
generating an partial image for a hidden portion of the product in the image by applying a second machine learning model to the image, the second machine learning model being based on a generative model including any one of a generative adversarial network (GAN), a conditional GAN (cGAN), a deep convolution GAN (DCGAN), an auto-encoder, or a variational auto-encoder (VAE); and
recognizing a product name of the product from the partial image.

3. The method of claim 2, further comprising:
controlling the first terminal to change a camera configuration of the first terminal based on a result of the acquiring the product information.

4. The method of claim 1, wherein the acquiring the product information comprises:
determining a representative color of the product by applying a third machine learning model based on machine learning to the image; and
recognizing a product name of the product from the image by applying a fourth machine learning model based on machine learning to the image,
wherein the estimating the location of the terminal is based on at least one of a portion of the product name or the representative color.

5. The method of claim 1, wherein the acquiring the product information comprises:
determining representative colors of the product by applying a third machine learning model to the image, the product including a plurality of items,
wherein the estimating the location of the first terminal is based on an arrangement of the representative colors.

6. The method of claim 1, wherein the loading the image captured by the first terminal comprises loading a plurality of images captured at different time points, and
wherein the estimating the location of the first terminal comprises:
determining representative colors of a plurality of products from the plurality of images by applying a third machine learning model based on machine learning to the plurality of images; and
estimating the location of the first terminal from the plurality of images based on a change of a location of the plurality of products in the plurality of images.

7. The method of claim 6, wherein the estimating the location of the first terminal comprises:
searching for an arrangement of the representative colors in a database based on a range in which the first terminal is capable of moving from a previously estimated location of the first terminal.

8. The method of claim 7, wherein the searching for the arrangement of the representative colors comprises:
estimating the range in which the first terminal is capable of moving based on acceleration information of the first terminal.

9. The method of claim 1, wherein the loading the image comprises loading a plurality of images captured in different directions, and
wherein the estimating the location of the first terminal is based on information about a plurality of products recognized from the plurality of images.

10. A non-transitory computer readable recording medium on which a computer-executable program for executing the method of claim 1 is recorded.

11. An apparatus for estimating an indoor location based on machine learning, the apparatus comprising:
a processor;
a memory electrically connected to the processor and configured to store at least one code executable by the processor and a parameter of a learning model based on machine learning; and
a database including product names respectively corresponding to a plurality of products and location information respectively corresponding to the plurality of products,
wherein the processor is configured to:
acquire product information related to a product recognized by applying a first learning model of the learning model to an image received from a terminal device through a network, and
estimate a location of the terminal device based on the product information and the location information.

12. The apparatus of claim 11, wherein the first learning model is a learning model trained to extract a product name from a product recognized from an image using, as training data, a reference product image and a product name of a product corresponding to the reference product image extracted from a database of products that are bought and sold in a store.

13. The apparatus of claim 11, wherein the database is generated based on images captured while a camera moves inside a store and location information for each of the images at which the camera performs photography.

14. The apparatus of claim 11, wherein at least one product within the image is partially hidden by another product or a surrounding environment, and
wherein the processor is further configured to:
generate an partial image for a hidden portion of the at least one product by applying a generative model to the image, and
identify a product name of the at least one product based on the partial image.

15. The apparatus of claim 14, wherein the generative model comprises any one of a generative adversarial network (GAN), a conditional GAN (cGAN), a deep convolution GAN (DCGAN), an auto-encoder, or a variational auto-encoder (VAE), which is trained to generate the partial image of the at least one product using, as training data, a reference product image extracted from a database of products that are bought and sold in a store.

16. The apparatus of claim 11, wherein the processor is further configured to:
estimate a representative color of the product based on a second machine learning model based on machine learning,
recognize a product name of the product by applying a third machine learning model based on machine learning, and
estimate a location of the terminal device based on at least one of a portion of the product name or the representative color.

17. An apparatus for estimating an indoor location based on machine learning, the apparatus comprising;
a processor;
a memory electrically connected to the processor and configured to store code executable by the processor and a parameter of a learning model based on machine learning; and
a camera configured to capture a surrounding image,
wherein the processor is configured to:
identify a product within the surrounding image by applying a first learning model of the learning model to the surrounding image captured by the camera,
acquire product information including a representative color of the product or a product name of the product, and
estimate a location in a store based on a search result of the product information from a database including product names respectively corresponding to a plurality of products and location information respectively corresponding to the plurality of products.

18. The apparatus of claim 17, wherein the processor is further configured to:
determine the representative color by applying a second machine learning model based on machine learning to the surrounding image,
identify the product name by applying a third machine learning model based on machine learning to the surrounding image, and
estimate the location in the store based on a search result of at least a portion of the product name and the representative color from the database.

19. The apparatus of claim 17, wherein the processor is further configured to:
determine representative colors of the product by applying a second machine learning model based on machine learning to the plurality of products, and
estimate the location in the store based on a search result of an arrangement of the representative colors from the database.

20. The apparatus of claim 17, wherein the surrounding image includes a plurality of images captured at different time points, and
wherein the processor is further configured to:
determine a plurality of representative colors of a plurality of products in the plurality of images by applying a second machine learning model based on machine learning to the plurality of images, and
estimate the location in the store based on a change of the plurality of representative colors in the plurality of images.
